(19) United States
(12) Patent Application Publication
(10) Pub. No.: US 2004/0188330 A1
(43) Pub. Date: Sep. 30, 2004

(54) Apparatus and system for automatically ordering salt and monitoring the salt in a brine tank

(76) Inventors: Larry R. Slawson, Fenton, MI (US); Robert Allen Wolfbrandt II, Ann Arbor, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/397,576

(22) Filed: Mar. 26, 2003

(51) Int. Cl. B01D 35/147

(52) U.S. Cl. 210/90; 210/190; 222/52

(57) ABSTRACT

The apparatus and material transport system conveys water softener salt from the outside of the house or structure to a water softener brine tank located in the basement. The apparatus may be used with existing homes or in newly built construction homes where a spacer sleeve is placed between concrete forms and the concrete foundation wall is poured around the sleeve. The apparatus includes an electrical circuit for automatically monitoring the amount of salt in the brine tank and when the salt is low, automatically ordering a delivery of replacement salt. A single portable loading hopper and elbow assembly is detachable mounted to the exterior wall of the structure for introducing salt into the brine tank. When the brine tank has been loaded, a buzzer is energized telling the responsible person in charge of loading the salt that the brine tank is full of salt. Thereafter, the portable loading hopper and attached component at detached from the feed tube mounted in the exterior wall of the structure and moved to another job site. The feed tube is closed by a suitable cap or plug. When the brine tank is low on salt, a pressure switch or sensor is energized signaling the computer at the receiving center that the supply of salt is low. The computer sends a message including the customer identification number to the computer at the salt delivery company indicating that the customer requires more salt.

### FIELD OF THE INVENTION

The present invention is directed to an apparatus and material transport system for conveying water softener salt from the outside of a house or structure to a water softener brine tank located in the basement of a house. Specifically, the apparatus includes an electrical circuit for automatically monitoring the amount of the salt in the brine tank and when the salt is low, automatically ordering a delivery of replacement salt. A wide number of homes or structures in a given locality can be modified to permit the use of a single portable loading hopper detachably mounted to the exterior wall of the structure for introducing salt into the brine tank. When the brine tank has been loaded, the portable loading hopper and attached component are detached from the feed tube mounted in the exterior wall of the structure and moved to another job site. The feed tube opening in the exterior wall through which the salt enters the brine tank is closed by a suitable cap or plug.

### BACKGROUND OF THE INVENTION

U.S. Pat. No. 5,996,852 entitled “Salt Conveying System for Water Softener”, inventor Paul J. Johnson, discloses a system where a hopper is utilized to supply water softener salt to a household water softener system. The system includes a loading hopper having a removable lid that is secured to an adjacent wall of the structure. Salt is fed into the upper end of the loading hopper and travels through the hopper to the lower end of the hopper where a downwardly sloping gravity feed sleeve is connected to the loading hopper. The feed sleeve is formed from a non-corrosive material and extends from the loading hopper through the floors and walls of the structure to a lower level of the structure. At its lower end, the feed sleeve is connected to a storage hopper suspended in the lower level of the structure by a hanging framework attached to the underside of a floor of the structure located directly above the storage hopper. The feed sleeve is attached adjacent the upper end of the storage hopper, thereby allowing the salt to migrate through the storage hopper to a dispensing spout connected to the lower end of the storage hopper. The dispensing spout is connected to a feed mechanism located beneath the storage hopper. The feed mechanism includes a connecting sleeve forming the exterior of the mechanism and a feed sleeve used to selectively dispense the salt from the feed mechanism through a tank sleeve connected between the feed mechanism and the water softener brine tank.

The Johnson U.S. Pat. No. 5,996,852 also discloses a salt transport system where a hopper is connected to an exterior wall of the house by a mounting plate secured between the loading hopper and the exterior wall. The loading hopper is formed of a non-corrosive material and includes a lid secured to the top end of the loading hopper by hinges. Attached to the lower end of the loading hopper is a feed sleeve which extends downwardly through its entire length and enters the house through a pair of feed sleeve openings in the exterior wall and a floor of the house. The feed sleeve is connected opposite the loading hopper directly to a brine tank located in the house adjacent to the foundation of the house. In both embodiments, the loading hopper is detachably connected to the wall on which it is mounted. In either embodiment, when the hopper is detached, an access door, such as a pivoted hinge cover, is used to close the feed sleeve opening.

### SUMMARY OF THE PRESENT INVENTION

It is a feature of the present invention to provide an improved material transport system for conveying from the outside of a house, a water softener salt to a water softener tank located in the basement or at a lower level in the house.

It is another feature of the present invention to use the improved material transport system and apparatus with existing homes or structures and in new homes or structures under construction where in each new construction a sleeve or pipe is inclined downwardly at an angle of approximately 30° and is located above grade at the appropriate height and inclination in wall forms and the concrete is poured around the pipe during the formation of the foundation wall.

Still another feature of the present invention is to provide an automated method or system for monitoring the amount of salt in the brine tank and relaying that information electronically via modern communication systems such as phone lines, internet, ISDN lines, WAN, etc.

A further feature of the present invention is to provide a material transport system including a portable loading hopper and elbow assembly located above grade at the exterior of the foundation wall of the building structure, with the portable loading hopper having an open top, a bottom end, converging side walls extending towards the bottom end and terming in an annular collar and a first 60° elbow having one end received in and secured to the annular collar of the hopper.

A still further feature of the present invention is to provide a material transport system of the aforementioned type wherein a first pipe or sleeve is located in the foundation wall of the structure and extends downwardly at an angle of approximately 30°, with the end surfaces of the first pipe respectively being flushed with the inner and outer surfaces of the foundation wall and a second pipe having a length greater than the length of the first pipe and extending through the first pipe, with the outer end portion of the second pipe being received in and secured to the other end of the first 60° elbow of the hopper and elbow assembly.

Another feature of the present invention is to provide a material transport system of the aforementioned type wherein a second 60° elbow is located within the interior of the structure and is connected on one end to the inner end portion of the second pipe; and a conduit connects the other end of the second 60° elbow to the water softener brine tank.

Still another feature of the present invention is to provide a material transport system of the aforementioned type wherein the second pipe is spaced from the first pipe or sleeve located in the foundation wall and a pair of tubular sleeves are telescoped over the second pipe and occupy the space in the foundation wall between the first and second pipes. As an alternative, the sleeve or first pipe has a pair of inserts integrally formed on the inner periphery thereof, with the inserts occupying the space in the foundation wall between the second pipe and sleeve.

A further feature of the present invention is to provide a material transport system of the aforementioned type wherein one end surface of each tubular sleeve is formed at a 30° angle and the other end surface of each tubular sleeve is formed at a 90° angle.

A still further feature of the present invention is to provide a material transport system of the aforementioned type wherein after the portable loading hopper and elbow assembly has been removed from the outer end portion of the second pipe, a water tight cap is placed over the outer end portion of the second pipe and a locking band surrounds the cap to secure it in place. As an alternative to the use of the cap and locking band, a plug-type closure or cap made from rubber is employed which is inserted into the outer end portion of the second pipe to close it and to prevent the elements from entering the system.

Another feature of the present invention is to provide a material transport system of the aforementioned type wherein an electrical circuit is provided with a pair of pressure switches and an alarm or buzzer, one of the pressure switches when activated dialing a computer when the level of salt in the brine tank is empty or low to order an additional supply of salt and the other of the pressure switches when the level of salt in the brine tank is full actuating the alarm or buzzer.

Still another feature of the present invention is to provide a material transport system of the aforementioned type wherein a vertically extending and moveable gauge rod floats on the salt in the brine tank to assist a person adjacent the brine tank to determine the amount of salt remaining therein.

Another feature of the present invention is to provide a material transport system of the aforementioned type wherein the gauge rod is marked with scale to indicate the number of bags of salt remaining in the brine tank.

Still another feature of the present invention is to provide a material transport system of the aforementioned type wherein the first 60° elbow is secured to the annular collar of the hopper by a plurality of radially spaced push pins which extend through aligned openings in the annular collar in the first end of the first 60° elbow to permanently secure the elbow with the collar of the hopper. As an alternative to the use of push-pins, the annular collar of the hopper is reduced in size to fit inside of the first 60° elbow.

A further feature of the present invention is to provide a material transport system of the aforementioned type wherein a cable is attached in one end to the annular collar of the hopper, a hinge pin is secured to the other end of the cable, with the hinge pin extending through aligned openings in one end of the first 60° elbow and the outer end portion of the second pipe to secure the portable loading hopper and elbow assembly to the second pipe, with the cable preventing the hinge pin from being lost when removed from the second pipe. As an alternative, other types of fastening means may be employed to secure the portable loading hopper and elbow assembly to the second pipe.

A still further feature of the present invention is to provide a material transportation system for existing homes wherein a clearance opening is drilled or cut in the foundation wall above ground level, with the clearance opening extending downwardly at an angle of approximately 30° from the outer surface to the inner surface of the foundation wall and a feed pipe having a length greater than the thickness of the foundation wall is placed in said clearance opening, with the feed pipe having inner and outer end portions extending away from the foundation wall.

Another feature of the present invention is to provide a material transport system for existing houses wherein the feed pipe is spaced from the clearance opening and a pair of tubular sleeves are telescoped over the inner and outer end portions of the feed pipe and respectively abuts the inner and outer surface of the foundation wall.

Still another feature of the present invention is to provide a material transport system for existing houses wherein one end surface of each tubular sleeve is formed at a 30° angle and the other end surface of each tubular sleeve is formed at a 90° angle, with the end surfaces formed at a 30° angle abutting the inner and outer surfaces of the foundation wall.

A further feature of the present invention is to provide a material transport system of the aforementioned type wherein cement is applied to the feed pipe extending through the clearance opening to fill and close the space adjacent the inner and outer surfaces of the foundation wall of the existing home.

Another feature of the present invention is to provide a material transport system for existing homes wherein cement is applied to the feed pipe to fill and close the space adjacent to the inner and outer surfaces of the foundation wall and a pair of tubular sleeves are telescoped over the feed pipe, one sleeve on each side of the foundation wall, each of the sleeves having one end surface formed at a 30° angle which abuts either the inner surface or the outer surface of the foundation wall.

Still another feature of the present invention is to provide a material transport system of the aforementioned type wherein the loading hopper and attached components are molded from a plastic material, as an example, polyvinyl chloride, to form an integral unit which is portable and detachable from the feed tube.

Finally, it is a further feature of the present invention to provide a material transport system of the aforementioned type that is simple in construction, efficient in operation and is easy to install and maintain as a manually operated system or as an automated system for reordering the salt when the salt in the brine tank is low or empty.

Various other features, objects and advantages of the present invention will be apparent from the following descriptions taken together with the drawings.

### BRIEF DESCRIPTION OF THE DRAWINGS

FIG. 1 is a vertical elevational view of the automated material transport system and apparatus according to the present invention for use with new home construction, with certain parts broken away and in section;

FIG. 1A is a fragmentary exploded view showing the relationship between the first sleeve or pipe which is imbedded in a concrete poured wall and the second or feed pipe and spacers which maintain the feed pipe in space relationship with the first sleeve or tube;

FIG. 2 is a fragmentary and enlarged view showing the relationship between the first sleeve or pipe around which the concrete foundation wall is poured and the second feed pipe and spacers which maintain the feed pipe in proper relationship with the first pipe;

FIG. 3 is a fragmentary view of the hopper and elbow assembly looking in the direction of arrow 3 of FIG. 2 and illustrating the manner in which a key connects the elbow of the hopper and elbow assembly to the feed pipe;

FIG. 4 is a sectional view taken on the line 4-4 of FIG. 2;

FIG. 5 is a perspective view showing the second or feed tube or pipe extending exteriorly of the foundation wall, with the portable loading hopper and elbow assembly removed, and with a water tight cap placed over the outer end of the feed pipe and with a locking band surrounding the cap to secure it in place;

FIG. 6 is a fragmentary elevational view of a concrete wall form, with the first pipe or sleeve mounted in the concrete form prior to the pouring of the concrete, with the sleeve held in place by a pair of nails, one nail in each of the panels of the concrete wall form;

FIG. 7 shows the concrete wall after the removal of the forms shown in FIG. 6, with the feed tube or second pipe extending through the first pipe or sleeve and held in spaced relationship by a pair of tubular sleeves which are telescoped over the second pipe and occupies the space in the foundation wall between the first and second pipes;

FIG. 8 is a sectional view taken on line 8-8 of FIG. 7;

FIG. 9 is a view similar to FIG. 1 but showing the automated material transport system for use in an existing structure or house where it is necessary to drill or cut a clearance hole or opening in the existing foundation wall above ground level before installing the system;

FIG. 10 is an exploded view of the feed pipe and a pair of tubular sleeves or spacers which are telescoped over the inner and outer end portions of the feed pipe and respectively abut the inner and outer surfaces of the foundation wall as illustrated in FIG. 9;

FIG. 11 is a flow chart for the electrical circuit capable of monitoring the level of salt in the water softener brine tank of either of the embodiments of FIGS. 1 and 9;

FIG. 12 is a flow chart for the computer located on the receiving end where the salt is ordered when required for either of the embodiments of FIGS. 1 and 9;

FIG. 13 is a schematic diagram of the electric circuit providing an automatic system for monitoring the amount of salt in a brine tank at a remote location and relaying such information to a receiving center through the means of communication systems such as computers, telephones and faxes;

FIG. 14 is an elevational view of a brine tank, with certain parts broken away, to show the sensors and tubes inside of a tank and to provide adjustability between the tubes and sensors; and

FIG. 15 is a top view of the brine tank looking in the direction of arrows 15-15 of FIG. 14.

### DETAILED DESCRIPTION OF THE PREFERRED EMBODIMENTS

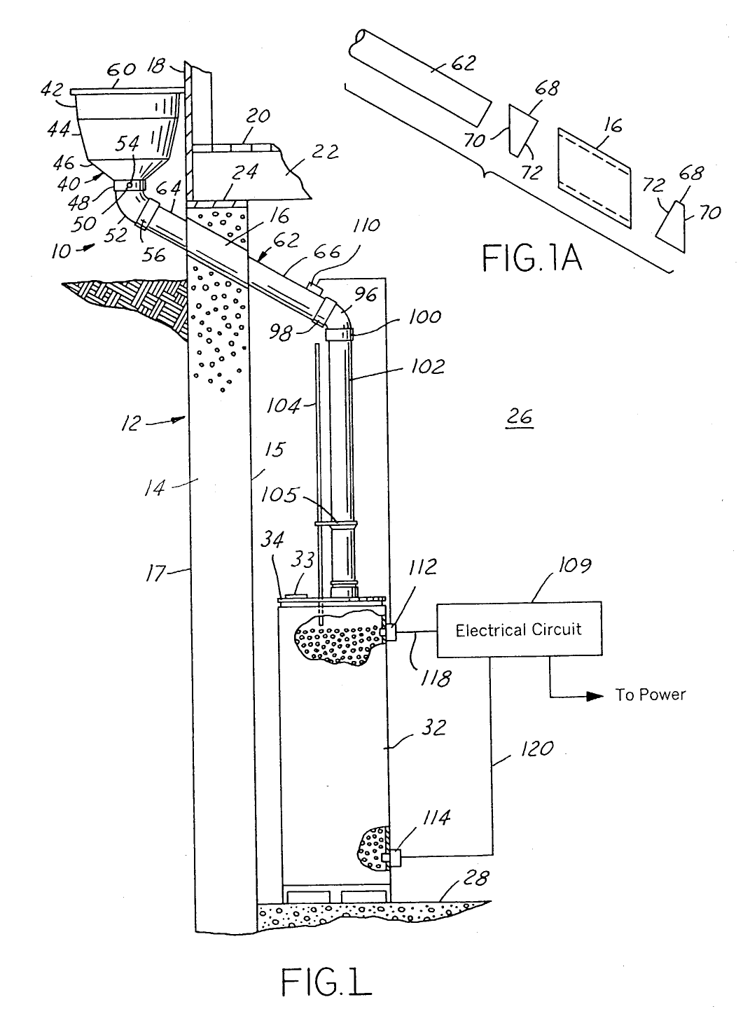

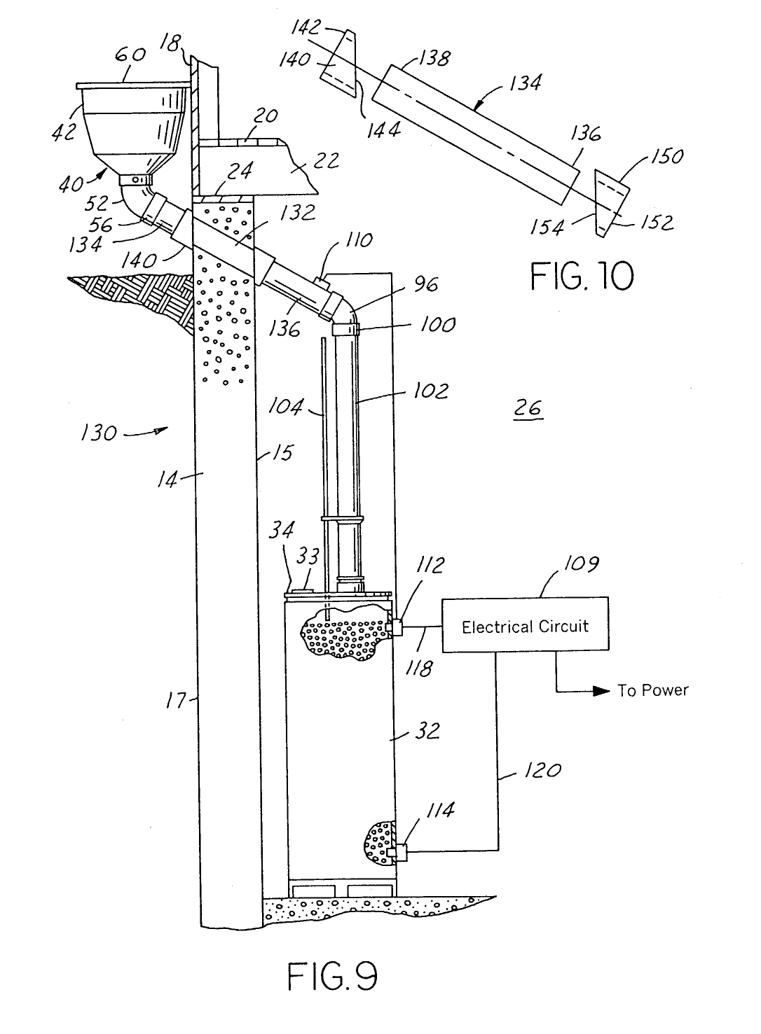

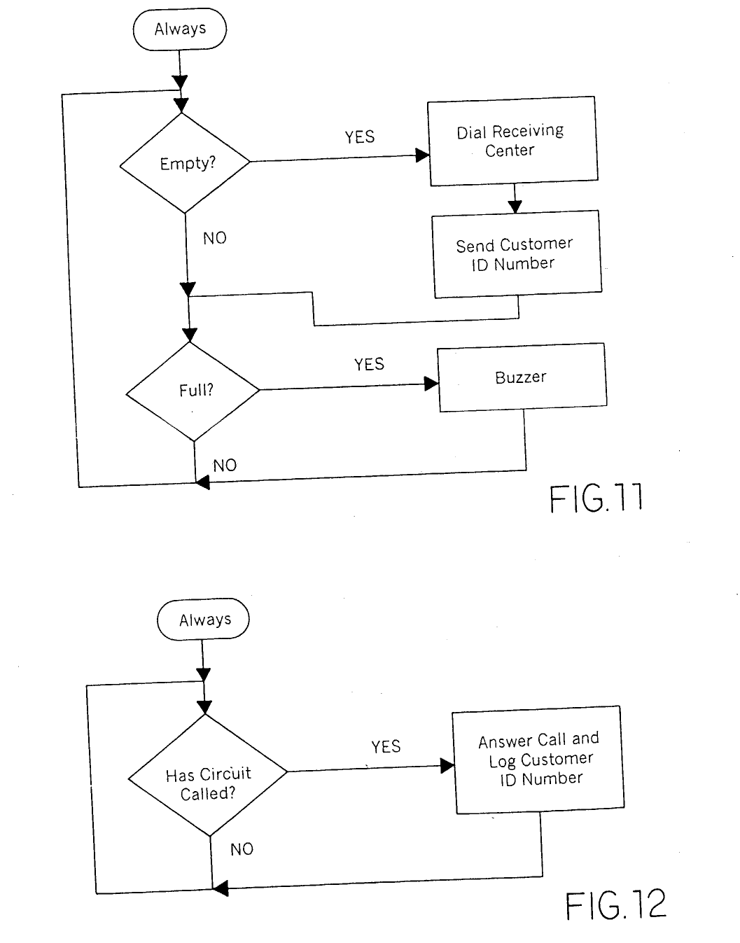

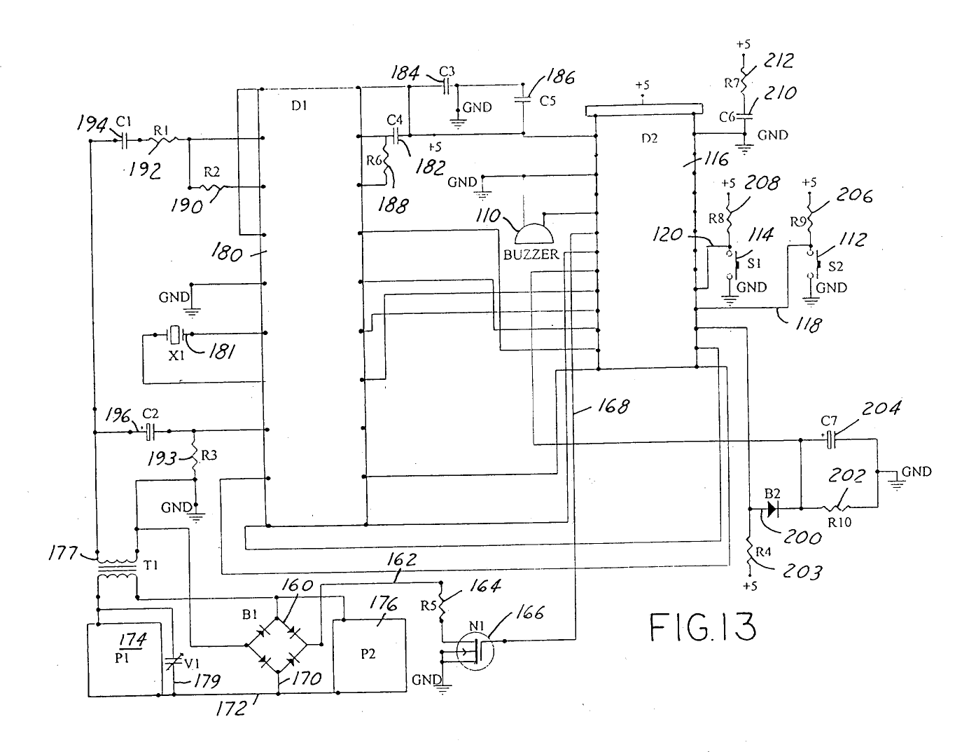

The first embodiment of the present invention illustrated in FIG. 1 shows a material transport system or apparatus 10 which is installed in a new structure or house at the time of the construction thereof. Thus, we refer to the material transport system of FIGS. 1-8 inclusive as being “new built” in contrast to the installation of a material transport system or apparatus in an “existing” structure or house as will be described in connection with FIGS. 9 and 10. The flow charts of FIGS. 11 and 12 and the schematic diagram of FIG. 13 can be used with either of the embodiments of FIGS. 1 and 9. Also the mechanical and structural elements of each of the embodiments of FIGS. 1 and 9 may be installed and used as a manually operated system without the assistance of an automatic electrical circuit for ordering replacement when the salt in the brine tank is low.

The embodiments of FIGS. 1 and 9 differ only in the areas where the feed pipes extend into the interior of the homes and the components thereof are illustrated in FIGS. 1A and 10. Therefore, like numerals will be used to identify similar components and equipment in FIGS. 1 and 9.

The new house or building structure 12 of FIG. 1 includes an exterior wall 14 that is made from concrete which is poured around an internal sleeve or pipe 16 as will subsequently be described. The house 12 includes an upper exterior wall 18, a floor 20 above ground level which is supported by a plurality of I beams 22. The I beams 22 are mounted on a bearing plate 24 located on the top surface of the foundation concrete wall 14. The ends of the I beams 22 are supported by the metal plate 24 and the concrete wall 14. The wall 14 has an inner surface or interior side 15 and an outer surface or exterior side 17. The structure or house 12 includes an interior space 26 beneath the floor 20 and above the basement or lower level concrete floor 28. Located within the space 26 is a brine tank 32 on the interior side of the foundation wall 14.

From time to time it is necessary to supply water softener salt to the brine tank 32. The problem of loading the salt into the brine tank 32 requires considerable effort. As an example, a brine tank of a water softener system can be loaded only by an individual or individuals carrying containers or bags of salt, typically 40-80 lb. bags of salt, from the outside to the interior space 26 in the basement or lower level of the house 12. It is then required to dump the bags of salt into the brine tank 32 after first removing the lid 34 provided on the tank 32. This method of filling the brine tank 32 may be beyond the capacity of a large segment of the population due to the weight of the bags of salt and the height of the brine tank 32. This problem has been addressed in the Johnson U.S. Pat. No. 5,996,852 by the utilization of a hopper located outside of the house and above grade so that the brine tank does not need to be continuously loaded by hand as the salt level decreases but rather the hopper is positioned higher than the brine tank to facilitate the dispensing of the salt. The tank 32 has an inspection cap 33 provided in the lid 34 which permits a person to look inside the tank 32 without removing the lid 34. In addition, the inspection cap 33 can be removed and additives added to the brine tank 32 without removing the lid 34.

The material transport system or apparatus 10 includes a portable loading hopper and elbow assembly 40 consisting of a hopper 42 having converging sidewalls 44 extending towards the bottom end of the hopper 42 and terminating in converging sidewalls 46. The sidewalls 46 have an integral annular collar 48. The annular collar 48 (FIG. 4) is provided with four radially spaced holes 50. The assembly 40 further includes an elbow 52 having one end received in the annular collar 48. The elbow 52 has corresponding openings 53 which are radially spaced apart and are aligned with the openings 50 provided in the annular collar 48 of the hopper 40. The elbow 52 is a 60 degree elbow which is secured to the annular collar 48 of the hopper 40 by a plurality of radially spaced push pins 54 (FIG. 4) which are received in the aligned holes 50 and 53 provided in the collar 48 and elbow 52. The push pins 54 permanently secure the elbow 52 to the collar 48 of the hopper 40 and thus provide a unitary assembly. The other end of the 60 degree elbow 52 is provided with a collar 56. As an alterative to the use of push pins 54, the annular collar 48 may be reduced in size to firmly fit inside of the first 60° elbow 52.

The portable loading hopper and elbow assembly 40 is located outside of the foundation wall 14 above grade as illustrated in FIG. 1. The assembly 40 is not attached to the wall 14 of the structure 12. The hopper 40 and elbow 52 may be molded from a plastic material such a polyvinyl chloride or other suitable plastic material.

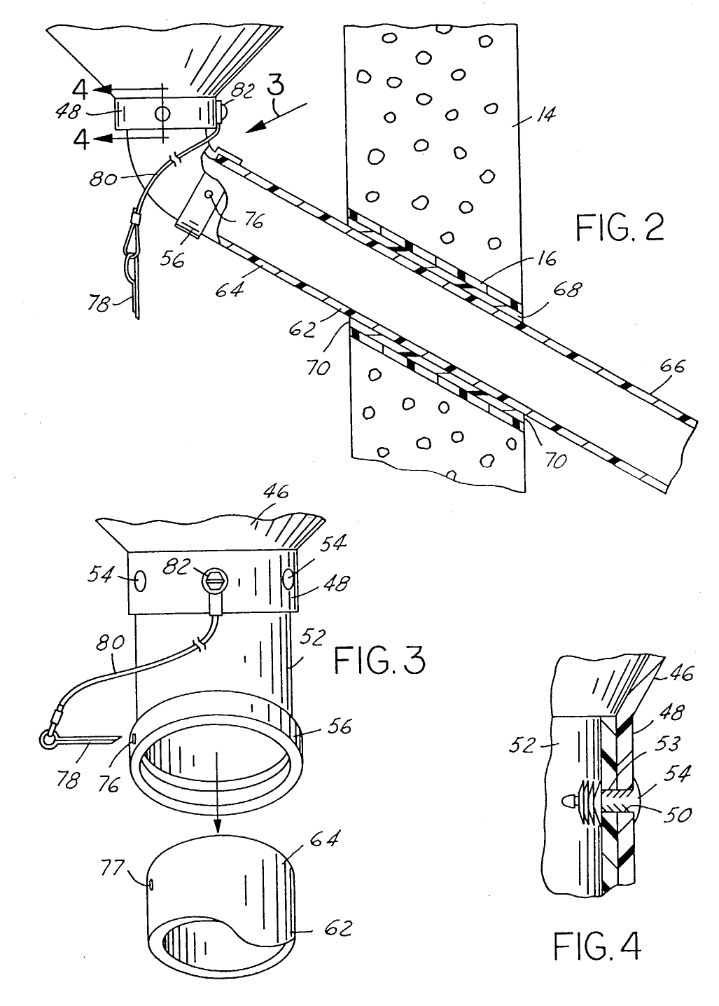

The upper end 60 of the hopper 42 is open. No cover or lid is normally provided. A feed pipe 62, also referred to herein as a second pipe, has an outer portion 64 and an inner portion 66. The second or feed pipe 62 extends through the first pipe or sleeve 16 and is held in spaced relation by a pair of tubular sleeves or spacers 68 as shown in FIG. 1A. The feed pipe 62 extends downwardly through the first pipe or sleeve 16 and is held in spaced relationship by the spacers 68. Each spacer or tubular sleeve 68 has one surface 70 formed at a 30 degree angle and the other end surface 72 formed at a 90 degree angle. The 30 degree end surfaces 70 are located in planes containing the inner and outer surfaces 15 and 17 of the concrete foundation wall 14 as best illustrated in FIG. 2. As an alternative, the sleeve or first pipe 16 may be manufactured with the pair of inserts 70 made integral with the inner surface or periphery thereof. Such integral inserts occupy the space in the foundation wall between the second or feed pipe 62 and the sleeve.

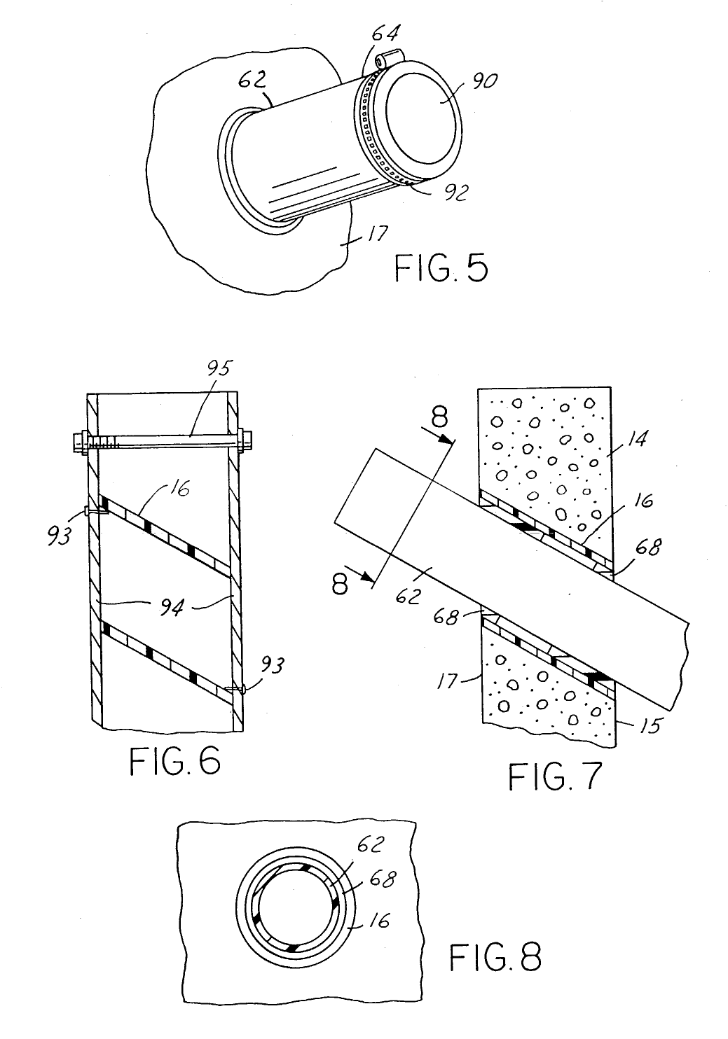

The outer end portion 64 of the feed tube or pipe 62 is received within the annular collar 56. The collar 56 and the corresponding end 64 of the pipe 62 have a pair of aligned holes 76 and 77 designed to receive a hinge pin 78 carried by a cable 80 on one end thereof, with the other end of the cable 80 secured by a fastener 82 to the collar 48 of the hopper 42. The purpose of the cable 80 and hinge pin 78 when in use is to connect the hopper and elbow assembly 40 to the feed pipe 62. With such a construction, after the brine tank 32 is filled with salt as will subsequently be described, the hinge pin 78 is removed from the collar 56 and the corresponding feed pipe 62, thus permitting the hopper and elbow assembly 40 to be removed to another job site. It should be appreciated alternative fastening means may be employed to secure the portable loading and elbow assembly to the second or feed pipe 62. Upon removal of the hopper and elbow assembly 40, a water tight cap 90 (FIG. 5) is placed over the outer end portion 64 of the second pipe 62. A locking band 92 surrounds the cap 90 and secures the cap 90 in its place on the pipe 62 as best illustrated in FIG. 5.

As an alternative to the cap 90 and locking band 92, a plug-type closure or cap may be utilized. The plug-type closure or cap may be utilized. The plug-type closure, as an example, has a body made from rubber. A washer and wing nut are provided on the bottom of the rubber body. A plastic lid is provided on the top of the rubber body and carries a threaded shank or bolt which extends axially through the rubber body into engagement with the threaded wing nut. When the bolt and wing nut are tightened, and the wing nut is moved closer to the top of the body, the rubber body is crushed and is moved or expands outwardly to form and create a seal between the plug and the opposing surface of the second or feed pipe.

When the house or structure 12 is under construction, the wall forms 94 are spaced apart by the bolts 95 as is known in the art. The sleeve 16 is mounted between the wall forms 94 and is held in place by a pair of nails 93 as shown in FIG. 6. The nails are used to freeze the pipe or sleeve 16 in a certain area. Thereafter, bolts 95 are tightened. The concrete is poured around the pipe 16 to complete the foundation wall 14. In place of bolts 95, conventional aluminum wall ties may be used as is known in the art. The wall forms 94 may be made from wood or aluminum panels.

The second pipe or feed pipe 62 has a length substantially greater than the length of the first pipe or sleeve 16 which is imbedded in the poured concrete wall 14. As mentioned previously, the feed pipe 66 extends through the first pipe 16 and is held in spaced relation by the spacers or sleeves 68. A second 60 degree elbow 96 is provided on the inner end of the downwardly inclined feed pipe 62 as best shown in FIG. 1. The second elbow 96 has a first collar 98 and a second collar 100. The inner end portion 66 of the feed pipe 62 is received in the collar 98. A vertically extending conduit 102 has an upper end received in the collar 100 of the second elbow 96. The elbow 96 may be secured to the feed pipe 62 and to the conduit 102 by releasable screws, not shown.

It will be appreciated that the brine tank 32 may be loaded manually from the interior space 26 by removing the lid 34 or preferably from the outside of the structure 12 utilizing the detachable hopper and elbow assembly 40. If the portable hopper and elbow assembly 40 is utilized, it is required that the person loading the brine tank 32 know when the tank 32 is full of salt. FIG. 1 illustrates a vertically extending gage rod 104 which extends through an opening in the brine tank lid 34. The gage rod 104 extends outwardly from the tank 32 through the interior space 26 and is movably carried by a bracket 105 secured to the conduit 102. The rod 104 floats on the salt in the brine tank 32 as shown. When the level of salt decreases in the brine tank 32, the gage rod 104 decreases or lowers itself into the tank 32. With an appropriate scale provided on the gage rod 104, a person adjacent the brine tank 32 can determine very readily the amount of salt remaining in the tank 32.

Although the mechanical features of the present invention may be utilized with a manual system for refilling the salt in the tank 32, the present system is primarily designed for use with an automated method or system for monitoring the amount of salt remaining in the brine tank 32 and to direct or relay that information to a receiving center with any appropriate electronic communication means. This includes, as an example, monitoring the salt with any means such as tactile sensors, optical sensors, video cameras, weight scales and etc. The information obtained as a result of the monitoring system is them relayed electronically via modern communication systems such as phone lines, internet connections, ISDN lines, WAN, etc.

Referring now to FIGS. 1 and 11-13, the electrical circuit 109 includes an electrically energized alarm or buzzer 110 mounted in the interior space 26 upon the inner end portion 66 of the feed tube 62. The electrical circuit 109, which is normally located at the home owner's house, for example, further includes an upper pressure switch or sensor 112 and a lower pressure switch or sensor 114. The pressure switches or sensors 112 and 114 are connected in the electrical circuit 109 and are mounted in the upper and lower portions respectively of the brine tank 32 as shown in FIG. 1. Pressure switch or sensor 112 is connected to the control circuit and specifically to the input of the microcontroller 116, FIG. 13 by line 118 of the circuit while the pressure switch or sensor 114 is connected to the microcontroller 116, FIG. 13 by a line 120. The purpose of the upper pressure switch or sensor 112 is to actuate the alarm or buzzer 110 for a set amount of time when the level of the salt in the brine tank 32 is full. The purpose of the other pressure switch or sensor 114, when the level of salt in the brine tank 32 is empty or low, is to send that information to the microcontroller 116, FIG. 13 portion of the electrical circuit 109 using line 120. The microcontroller 116 included in the electrical circuit 109 contains a program, which constantly monitors pressure switches or sensors 112 and 114 and activates the alarm or buzzer 110 when pressure switch or sensor 112 has been activated and sends the customer ID number to a fax machine, telephone, computer modem or other communication device when pressure switch or sensor 114 has been activated indicating at the delivery company's receiving center that a shortage of salt has occurred. Thus the salt delivery company or service is alerted immediately to the fact that it is time to deliver salt to the home.

The flow chart of the program stored in the microcontroller 116 as shown in FIG. 11 illustrates the two conditions of what occur when the brine tank 32 is empty and when it is full of salt. When the last mentioned condition occurs, the buzzer 110 is energized for a set amount of time, signaling the salt delivery person that the tank is full. When the salt is low, as shown in FIG. 11, a signal is sent to the microcontroller 116, where the customer ID is stored. The electrical circuit 109 then dials the delivery service and sends the customer ID number indicating that the customer requires a delivery of salt.

FIG. 12 shows the flow chart of a program that receives the customer ID from the electrical circuit 109. This program resides on a computer at the salt delivery service which is connected to the phone line by a modem. If the delivery service chooses to use a fax machine or a phone to receive the customer ID, the program illustrated in FIG. 12 would not be necessary.

The electrical circuit 109 illustrated in FIG. 13 interfaces to the tip and ring wires of the phone line through the RJ11 jack 174. RJ11 jack 176 is used as an input for a telephone through which a customer ID number can be entered and stored in the microcontroller 116. A varistor 179 is connected across the tip and ring signals to avoid voltage spikes which can occur on the phone line. A bridge rectifier 160 is connected to the RJ11 jack 174 and the microcontroller 116 through a resistance 164 and an n-channel MOSFET 166. The bridge rectifier 160 is used to protect against incorrect polarity on the phone line, which can be caused by faulty wiring in the home. The n-channel MOSFET 166 is used as a switch to turn the phone line on and off and the resistor 164 is the load for the phone line. The telephone transformer 177 provides the 600 ohm to 600 ohm impedance matching necessary to inject and receive DTMF tones through the telephone line.

The electrical circuit 109 also includes a dual tone multifrequency generator (DTMF) 180 used to generate and decode DTMF tones used by the telephone network. A crystal oscillator 181 is wired to the dual tone multifrequency generator (DTMF) 180 so that it can produce tones. Capacitor 194 and resistors 192 and 190 are used to connect the input of the DTMF generator 180 to the telephone transformer 177. Capacitor 196 is used to connect the output of the DTMF generator 180 to the telephone transformer 177.

The microcontroller 116 is also connected to a series of circuit elements including a diode 200, a resistors 202, 203 and a capacitor 204. The sensor 112 and sensor 114 are connected to resistors 206 and 208 respectively. The microcontroller 116 is also connected to capacitor 210 and resistor 212.

FIG. 12 illustrates the flow chart for the computer on the receiving end. The computer at the salt delivery service answers the call from the electrical circuit 109 and logs in the customer identification number. Thereafter, the order is filled by the delivery service.

The description for the second embodiment of FIGS. 9 and 10 uses the same numbers as the embodiment of FIG. 1-8 and 11-13 to designate similar parts.

The material transport system or apparatus 130 is for existing homes where it is necessary to cut or drill a clearance opening 132 in the foundation wall 14. The foundation wall 114 is illustrated as being a concrete wall; however, the invention is also applicable to foundation walls made from bricks or concrete blocks and walls made from other commercially available building materials.

The clearance opening 132 is cut an angle extending from the outer surface 17 through the inner surface 15 of the wall 14. The outside entrance to the clearance opening 132 is approximately two to four inches above ground level. The hole or opening 132 is approximately four and one-half inches in diameter in order to receive the four inch feed pipe 134. As mentioned previously, the clearance hole 132 can be drilled or cut through brick walls, concrete block walls or the like. The feed pipe 134 has an inner end portion 136 and an outer end portion 138 as best shown in FIG. 10. It is necessary during the construction to close the gap between the feed pipe 134 and the clearance opening 132. It is adviseable to use a caulking gun or a persons finger to fill the gap around the pipe 134 utilizing silicone cement or other similar building materials. The outer tubular collar or sleeve 140 has a pair of end surfaces 142 and 144. End surface 142 is formed on a 90° angle while end surface 144 is formed on a 30° angle.

After caulking and closing the clearance gap, the collar or sleeve 140 is slid down the pipe 134. Before sliding, glue is applied to the pipe 134 and thereafter the collar or sleeve 140 is moved down the pipe 134 with the surface 144 on the collar 140 contacting the outer surface 17 of the foundation wall 14. A second collar or sleeve 150 having a pair of surfaces 152 and 154 is provided on the inside of the foundation wall 14. The inner portion of the feed pipe 134 is applied with an adhesive or glue and thereafter the collar 150 is slid along the pipe 134 to bring the surface 154 into contact with the inner surface 15 of the foundation wall 14 as best illustrated in FIG. 9. It takes both collars or sleeves 140 and 150 to bear against the wall 14 to prevent the pipe from going in and out and from rotating in the clearance opening 132. Once the collars 140 and 150 have been installed, if any gaps remain, it is advisable to fill the gaps with a silicone cement or other adhesive utilizing a caulking gun or a persons finger to accomplish the task at hand.

The outer end portion 138 of the feed tube 134 is received in the collar 56 of the hopper and elbow assembly 40 as is described in connection with the first embodiment. After the brine tank 32 has been loaded with salt, the hopper and elbow assembly 40 is removed and moved to another job site. Thereafter, a cap unit is placed over the open end of the feed pipe 134 such as is shown in FIG. 5 of the first embodiment. The monitoring the of salt in the brine tank 32 is automated through the use of the electrical circuit and flow charts s illustrated in FIGS. 11-13 inclusive.

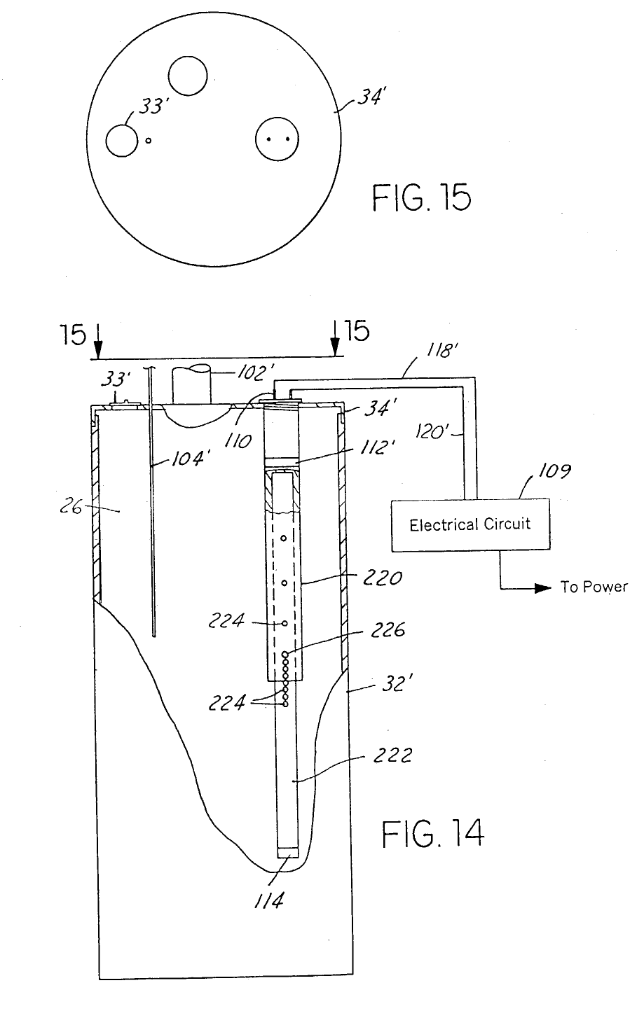

A modified brine tank 32′ is illustrated in FIGS. 14 and 15. The lid 34′ has an inspection cap 33′. The gauge rod 104′ extends outwardly from the tank 32′ through the interior space 26 and is moveably carried by a bracket, not shown, connected to the conduit 102′.

Rather than mounting the two sensors 112′ and 114′ on the exterior of the tank 32′ as illustrated in FIGS. 1 and 9, the sensors 112′ and 114′ are each carried respectively by a pair of elongated tubular elements 220 and 222. Tubular element 220 and 222 are each provided with a plurality of longitudinally spaced openings 224. The rod or tube 222 carrying the sensor 114′ may be adjusted lengthwise relative to the other rod or tube 220 to permit the device to fit different sizes of brine tanks. In addition, the adjustability between the tubes 220 and 222 adjust for the amount of time required for delivering salt to the home once the order is placed.

The sensor 112′ and 114′ are connected respectively to the electrical circuit 109 by the lines 118′ and 120′. The rods or tubes 220 and 222 are held in an adjusted position by means of a pin 226 which extends through a pair of aligned openings 224 provided in the tube 220 and 222.

From the foregoing description, various modifications and changes in the apparatus and in the method of operating such apparatus will occur to those skilled in the art, all such modifications or changes coming within the scope of the appended claims are intended to be included therein.

We claim:

1. The combination of a structure and a material transport system for conveying water softener salt to a water softener brine tank located in the interior of the structure, said structure having a foundation wall with inner and outer surfaces;
said material transport system having a first pipe located in the foundation wall of said structure and extending downwardly at an angle of approximately 30°, with the end surfaces of said first pipe respectively being flush with the inner and outer surfaces of said foundation wall;
a second pipe having a length greater than the length of said first pipe and extending through said first pipe, said second pipe having inner and outer end portions extending away from said foundation wall opposite said inner and outer surfaces;
a portable loading hopper and elbow assembly located at the exterior of said foundation wall;
said portable loading hopper having an open top and a bottom end, with said hopper having converging side walls extending towards said bottom end and terminating in an annular collar;
said hopper and elbow assembly further including a first 60° elbow having one end received in and secured to said annular collar of said hopper;
said outer end portion of said second pipe being received in and secured to the other end of said first 60° elbow of said hopper and elbow assembly;
a second 60° elbow located within the interior of said structure and connected on one end to said inner end portion of said second pipe; and
a conduit connecting the other end of said second 60° elbow to the water softener brine tank.

2. The combination of a structure and a material transport system as recited in claim 1, wherein said foundation wall is made from concrete.

3. The combination of a structure and a material transport system as recited in claim 1, wherein said foundation wall is constructed from concrete which is poured around said first pipe inclined at approximately a 30° angle.

4. The combination of a structure and a material transport system as recited in claim 1, wherein said second pipe is spaced from said first pipe; and a pair of tubular sleeves are telescoped over said second pipe and occupy the space in the foundation wall between said first and second pipes.

5. The combination of a structure and a material transport system as recited in claim 4, wherein one end surface of each tubular sleeve is formed at a 30° angle and the other end surface of each tubular sleeve is formed at a 90° angle.

6. The combination of a structure and a material transport system as recited in claim 1, wherein after said portable loading hopper and elbow assembly has been removed from said outer end portion of said second pipe, a water tight cap is placed over said outer end portion of said second pipe; and a locking band surrounds said cap to secure it in place.

7. The combination of a structure and a material transport system as recited in claim 1, wherein an electrical circuit is provided with a pair of pressure switches and an alarm, one of said pressure switches when actuated dialing a computer when the level of salt in said brine tank is empty or low to order an additional supply of salt and the other of said pressure switches when the level of salt in the brine tank is full activating said alarm.

8. The combination of a structure and a material transport system as recited in claim 1, wherein said first and second pipes, said loading hopper and said 30° and 60° elbows are made from a plastic material.

9. The combination of a structure and a material transport system as recited in claim 8, wherein said plastic material is made from polyvinyl chloride.

10. The combination of a structure and a material transport system as recited in claim 1, wherein a vertically extending and movable gage rod floats on the salt in the brine tank, said gage rod extending from said brine tank to assist a person adjacent the brine tank to determine the amount of salt remaining therein.

11. The combination of a structure and a material transport system as recited in claim 8, wherein said gage rod is marked with a scale to indicate the number of bags of salt in the brine tank.

12. The combination of a structure and a material transport system as recited in claim 1, wherein said first 60° elbow is secured to the annular collar of said hopper by a plurality of radially spaced push pins which extend through aligned openings in said annular collar and said one end of said first 60° elbow to permanently secure said last mentioned elbow to the collar of said chute.

13. The combination of a structure and a material transport system as recited in claim 1, wherein a cable is attached on one end of said annular collar of said hopper, a hinge pin secured to the other end of said cable, said hinge pin extending through aligned openings in said one end of said first 60° elbow and said outer end portion of said second pipe to secure the portable loading hopper and elbow assembly to said second pipe; said cable preventing said hinge pin from being lost when removed from said second pipe.

14. The combination of a structure and a material transport system for conveying water softener salt to a water softener brine tank located in the interior of the structure, said structure having a foundation wall with inner and outer surfaces;
a clearance opening located in said foundation wall above ground level and extending downwardly at an angle of approximately 300 from the outer surface to the inner surface;
a pipe having a length greater than the thickness of said foundation wall, said pipe having inner and outer end portions extending away from said foundation wall opposite said inner and outer surfaces;
a portable loading hopper and elbow assembly located at the exterior of said foundation wall;
said portable loading hopper having an open top and a bottom end, with said hopper having converging side walls extending towards said bottom end and terminating in an annular collar;
said hopper and elbow assembly further including a first 60° elbow having one end received in and secured to said annular collar of said hopper;
said outer end portion of said pipe being received in and secured to the other end of said first 60° elbow of said hopper and elbow assembly;
a second 60° elbow located within the interior of said structure and connected on one end to said inner end portion of said pipe; and
a conduit connecting the other end of said second 60° elbow to the water softener brine tank.

15. The combination of a structure and a material transport system as recited in claim 14, wherein said foundation wall is made from concrete.

16. The combination of a structure and a material transport system as recited in claim 14, wherein said foundation wall is made from bricks and said clearance opening is cut through said bricks above ground level.

17. The combination of a structure and a material transport system as recited in claim 14, wherein said foundation wall is made from cement or cement blocks and said clearance opening is cut through said cement or cement blocks above ground level.

18. The combination of a structure and a material transport system as recited in claim 14, wherein said pipe is spaced from said clearance opening; and a pair of tubular sleeves are telescoped over said inner and outer end portions of said connector pipe and respectively abut said inner and outer surfaces of said foundation wall.

19. The combination of a structure and a material transport system as recited in claim 18, wherein one end surface of each tubular sleeve is formed at a 30° angle and the other end surface of each tubular sleeve is formed at a 90° angle, said end surfaces formed at a 30° angle abutting said inner and outer surfaces of said foundation wall.

20. The combination of a structure and a material transport system as recited in claim 18, wherein cement is applied to said connector pipe to fill and close the space adjacent to said inner and outer surfaces.

21. The combination of a structure and a material transport system as recited in claim 14, wherein cement is applied to said connector pipe to fill and close the space adjacent to said inner and outer surfaces; and a pair of tubular sleeves are telescoped over said connector pipe, one sleeve on each side of said foundation wall; each of said sleeves having one end surface formed at a 30° angle which abuts either the inner surface or outer surface of said foundation wall.

22. The combination of a structure and a material transport system as recited in claim 14, wherein an electrical circuit is provided with a pair of pressure switches and an alarm, one of said pressure switches when actuated dialing a computer when the level of salt in said brine tank is empty or low to order an additional supply of salt and the other of said pressure switches when the level of salt in the brine tank is full activating said alarm.
